(19) United States
(12) Patent Application Publication
(10) Pub. No.: US 2010/0034727 A1
(43) Pub. Date: Feb. 11, 2010

(54) PROCESS FOR PRODUCING GYPSUM

(76) Inventors: Tarja Turkki, Helsinki (FI); Perttu Heiska, Espoo (FI); Pasi Hagelberg, Espoo (FI); Veikko Laakso, Saukkola (FI)

Correspondence Address: CANTOR COLBURN, LLP, 20 Church Street, 22nd Floor, Hartford, CT, 06103, US

(21) Appl. No.: 12/525,149

(22) PCT Filed: Feb. 1, 2008
(86) PCT No.: PCT/FI2008/000022

§ 371 Date: Oct. 23, 2009

(30) Foreign Application Priority Data
Feb. 2, 2007 (FI) 20070093

(51) Int. Cl. C01F 11/46

(52) U.S. Cl. 423/555

(57) ABSTRACT

The invention relates to a process for the preparation of a gypsum product wherein calcium sulphate hemihydrate and/or calcium sulphate anhydrite and water are contacted so that the calcium sulphate hemihydrate and/or calcium sulphate anhydrite and the water react with each other and form a gypsum product. The reaction mixture has a dry matter content of 34-84% by weight in order to obtain a gypsum product which consists of crystals that are small, flat and of as equal size as possible. The invention also relates to a product prepared by this process. A gypsum product is formed which consists of essentially intact crystals having a size of between 0.1 and below 2.0 μm. The products are applicable e.g. as fillers or coating pigments in e.g. paper industry.

### OBJECTS OF THE INVENTION

The invention relates to a process for the preparation of a gypsum product wherein calcium sulfate hemihydrate and/or calcium sulfate anhydrite and water are contacted so that the calcium sulfate hemihydrate and/or calcium sulfate anhydrite and the water react with each other and form a gypsum product. The invention also relates to a product prepared by this process.

### BACKGROUND OF THE INVENTION

Gypsum or calcium sulfate dihydrate CaSO₄.2H₂O is suitable as material for both coating and filler pigments, especially in paper products. Especially good coating and filler pigment is obtained if the particular gypsum product has crystals, which are small, flat, broad (platy) and of equal size.

The crystal size of the gypsum product particles is expressed as the weight average diameter D₅₀ of the particles contained therein. More precisely, D₅₀ is the diameter of the presumably round particle, smaller than which particles constitute 50% of the total particle weight. D₅₀ can be measured with an appropriate particle size analyzer, such as Sedigraph 5100.

The flatness of a crystal means that it has two parallel surfaces larger than the other surfaces. The form of flat crystals is suitably expressed by means of the shape ratio SR. The SR is the ratio of the crystal length (the longest measure) to the crystal thickness (the shortest transverse measure). By the SR of the claimed gypsum product is meant the average SR of its individual crystals.

Plateness is suitably expressed by means of the aspect ratio AR. The AR is the ratio between the crystal length (the longest transverse measure) and the crystal width (the longest transverse measure) e.g. the ratio between the length and the diameter of a cylinder tightly surrounding the crystal. By the AR of the claimed gypsum product is meant the average AR of its individual crystals.

Both the SR and the AR of the gypsum product can be estimated by examining its scanning electron micrographs. A suitable scanning electron microscope is the Philips FEI XL 30 FEG.

Equal crystal particle size means that the crystal particle size distribution is narrow. The width is expressed as the gravimetric weight distribution (D₇₅−D₂₅)/D₅₀ wherein D₇₅, D₂₅ and D₅₀ are the diameters of the presumably round particles, smaller than which particles constitute 75, 25 and 50%, respectively, of the total weight of the particles. The width of the particle distribution is obtained with a suitable particle size analyzer such as the above mentioned type Sedigraph 5100.

Gypsum occurs as a natural mineral or it is formed as a by-product of chemical processes, e.g. as phosphogypsum or flue gas gypsum. In order to refine the gypsum further by crystallizing it into coating pigment or filler, it must first be calcined into calcium sulfate hemihydrate (CaSO₄.½H₂O) after which it may be hydrated back by dissolving the hemihydrate in water and precipitating to give pure gypsum. Calcium sulfate may also occur in the form of anhydrite lacking crystalline water (CaSO₄).

Depending on the calcination conditions of the gypsum raw material, the calcium sulfate hemihydrate may occur in two forms; as α- and β-hemihydrate. The β-form is obtained by heat-treating the gypsum raw material at atmospheric pressure while the α-form is obtained by treating the gypsum raw material at a steam pressure which is higher than atmospheric pressure or by means of chemical wet calcination from salt or acid solutions at 45° C.

WO 88/05423 discloses a process for the preparation of gypsum by hydrating calcium sulfate hemihydrate in an aqueous slurry thereof, the dry matter content of which is between 20 and 25% by weight. Gypsum is obtained, the largest measure of which is from 100 to 450 μm and the second largest measure of which is from 10 to 40 μm.

AU620857 (EP0334292 A1) discloses a process for the preparation of gypsum from a slurry containing not more than 33.33% by weight of ground hemihydrate, thereby yielding needle-like crystals having an average size of between 2 and 200 μm and an aspect ratio between 5 and 50. See page 15, lines 5 to 11, and the examples of this document.

US 2004/0241082 describes a process for the preparation of small needle-like gypsum crystals (length from 5 to 35 μm, width from 1 to 5 μm) from an aqueous slurry of hemihydrate having a dry matter content of between 5 and 25% by weight. The idea in this US document is to reduce the water solubility of the gypsum by means of an additive in order to prevent the crystals from dissolving during e.g. paper manufacture.

The above papers expressly aim at preparing needle-like crystals which are suitable as reinforcement. In them gypsum products and their preparation are described, the needle-like forms of which are unsatisfactory when striving for high gloss and opacity. As was stated above, in order to achieve high whiteness and opacity, very small particles are needed. Such particles have so far been obtained only by grinding gypsum.

The processes of prior art have high water content which makes the adjustment of dry matter content in the end product troublesome. Typically a dewatering step is required in the processing of the pigment. The size and shape of the particle is difficult to adjust. In order to achieve a desired size and shape one has to use certain starting material (such as calcium sulfate hemihydrate, in particular the β- or α-form), a pre-treatment, such as grinding, of the starting material or an expensive crystallization habit modifier in the reaction. To prepare the desired end product the reaction conditions, such as adjusting the temperature and/or pH, is necessary, which increases the production costs due to required cooling. In conventional processes the preparation of small particles requires a grinding or crushing step, which causes a considerable consumption of energy being a major cost factor in the production of pigment.

### DESCRIPTION OF THE INVENTION

The aim of the invention is to provide a process for the preparation of gypsum crystals of which are intact, small, flat and as equal as possible in size. The purpose of the invention is also to provide a process that is simple, scalable, adaptable to reaction conditions and raw materials and thus considerably less expensive than prior art techniques.

The above mentioned purposes have now been achieved with a new process of the invention, where calcium sulfate hemihydrate and/or calcium sulfate anhydrite and water are contacted so that they react with each other and form a gypsum product. The reaction mixture has a dry matter content of between 34 and 84% by weight in order to obtain a gypsum product which consists of crystals that are small, flat and of as equal size as possible. According to the invention it is possible to obtain gypsum crystals of different crystal size and shape factor by adjusting the dry matter content. It is thus possible to produce gypsum products that are applicable e.g. as filler or coating pigments in e.g. paper industry. The gypsum product prepared with the process of the invention has excellent properties for example to coating applications, where small crystals with a smooth surface are a prerequisite for high opacity and gloss. In addition the product can be used as plastics filler, and as a raw material in glass industry, cosmetics, printing inks, building materials and paints.

The process also has the advantage that less pre-treatment and cheaper or no crystallization habit modifier are needed. The product need not be crushed or ground.

In the claimed process, the calcium sulfate hemihydrate and/or calcium sulfate anhydrite are preferably used in such an amount that the reaction mixture formed from it/them and the water has a dry matter content of between 40 and 84% by weight, more preferably between 50 and 80% and most preferably between 57 and 80% by weight.

In this connection, the term “dry matter content” means essentially the same as “solids content”, as the dissolved hemihydrate and/or anhydrite forming a part of the “dry matter” is very small compared to the amount of undissolved hemihydrate and/or anhydrite forming the initial “solids content”.

According to the process of the invention, water can be contacted with
calcium sulfate hemihydrate
calcium sulfate anhydrite
a mixture of calcium sulfate hemihydrate and calcium sulfate anhydrite
a mixture of calcium sulfate hemihydrate and calcium sulfate dihydrate
a mixture of calcium sulfate anhydrite and calcium sulfate dihydrate or
a mixture of calcium sulfate hemihydrate, calcium sulfate anhydrite and calcium sulfate dihydrate.

In the process according to the invention, β-calcium sulfate hemihydrate is typically used. It may be prepared by heating gypsum raw-material to a temperature of between 140 and 300° C., preferably from 150 to 200° C. At lower temperatures, the gypsum raw-material is not sufficiently dehydrated and at higher temperatures it is over-dehydrated into anhydrite. The calcinated calcium sulfate hemihydrate usually contains impurities in the form of small amounts of calcium sulfate dihydrate and/or calcium sulfate anhydrite. It is preferable to use β-calcium sulfate hemihydrate, whereby the gypsum raw material is heated to the require temperature as fast as possible.

It is also possible to use calcium sulfate anhydrite as starting material for the process of the invention. The anhydrite is obtained by calcination of gypsum raw material. There are three forms of anhydrite; the first one, the so-called Anhydrite I, is unable to form gypsum by reaction with water like the insoluble Anhydrites II-u and II-E. The other forms, the so called Anhydrite III, also known as soluble anhydrite has three forms: β-anhydrite III, β-anhydrite III′, and α-anhydrite III and Anhydrite II-s form pure gypsum upon contact with water.

The temperature of the water in the reaction mixture can be anything between 0 and 100° C. and it can even be in the form of water vapor.

As the calcium sulfate hemihydrate and water have been contacted, they are allowed to react into calcium sulfate dihydrate i.e. gypsum. The reaction takes place e.g. by mixing, preferably by mixing strongly, said substances together for a sufficient period of time, which can easily be determined experimentally. Strong mixing is necessary because at the claimed high dry matter contents, the slurry is thick and the reagents do not easily come into contact with each other. The initial pH is typically between 3.5 and 9.0, preferably between 4.0 and 7.5. If necessary, the pH is regulated by means of an aqueous solution of NaOH and/or H₂SO₄, typically a 10% solution of NaOH and/or H₂SO₄.

In one embodiment of the invention, the calcium sulfate hemihydrate and/or calcium sulfate anhydrite, the water and a crystallization habit modifier are contacted. The sequence may be of any order. It is, however, preferable to contact the crystallization habit modifier with the water before the hemihydrate and/or the anhydrite.

The crystallization habit modifier is preferably a compound having in its molecule one or several carboxylic or sulfonic acidic groups, or a salt of such a compound. According to one embodiment of the invention, the crystallization habit modifier is an inorganic acid, oxide, base or salt. Examples of useful inorganic oxides, bases and salts are AlF₃, Al₂(SO₄)₃, CaCl₂, Ca(OH)₂, H₃BO₄, NaCl, Na₂SO₄, NaOH, NH₄OH, (NH₄)₂SO₄, MgCl₂, MgSO₄ and MgO.

According to another embodiment, the crystallization habit modifier is an organic compound, which is an alcohol, an acid or a salt. Suitable alcohols are methanol, ethanol, 1-butanol, 2-butanol, 1-hexanol, 2-octanol, glycerol, i-propanol and alkyl polyglucoside based C₈-C₁₀-fatty alcohols.

Among the organic acids may be mentioned carboxylic acids such as acetic acid, propionic acid, succinic acid, citric acid, tartaric acid, ethylene diamine succinic acid (EDDS), iminodisuccinic acid (ISA), ethylene diamine tetraacetic acid (EDTA), diethylene triamine pentaacetic acid (DTPA), nitrilotriacetic acid (NTA), N-bis-(2-(1,2-dicarboxyethoxy)ethyl aspartic acid (AES), and sulfonic acids such as amino-1-naphthol-3,6-disulfonic acid, 8-amino-1-naphthol-3,6-disulfonic acid, 2-aminophenol-4-sulfonic acid, anthrachinone-2,6-disulfonic acid, 2-mercaptoethanesulfonic acid, poly(styrene sulfonic acid), poly(vinylsulfonic acid), as well as the di-, tetra- and hexa-aminostilbenesulfonic acids.

Among the organic salt may be mentioned the salts of carboxylic acids such as Mg formiate, Na— and NH₄-acetate, Na₂-maleate, NH₄-citrate, Na₂-succinate, K-oleate, K-stearate, Na₂-ethyelendiamine tetraacetic acid (Na₂-EDTA), Na₆-aspartamic acid ethoxy succinate (Na₆-AES) and Na₆-aminotriethoxy succinate (Na₆-TCA).

Also the salt of sulfonic acids are useful, such as Na-n-(C₁₀-C₁₃)-alkylbenzene sulfonate, C₁₀-C₁₆-alkylbenzene sulfonate, Na-1-octyl sulfonate, Na-1-dodecane sulfonate, Na-1-hexadecane sulfonate, the K-fatty acid sulfonates, the Na—C₁₄-C₁₆-olefin sulfonate, the Na-alkylnaphthalene sulfonates with anionic or non-ionic surfactants, di-K-oleic acid sulfonates, as well as the salts of di-, tetra-, and hexaaminostilbene sulfonic acids. Among organic salts containing sulfur should also be mentioned the sulfates such as the C₁₂-C₁₄-fatty alcohol ethersulfates, Na-2-ethyl hexyl sulfate, Na-n-dodecyl sulfate and Na-lauryl sulfate, and the sulfosuccinates such as the monoalkyl polyglycol ether of Na-sulfosuccinate, Na-dioctyl sulfosuccinate, and Na-dialkyl sulfosuccinate.

Phosphates may also be used, such as the Na-nonylphenyl- and Na-dinonyl phenylethoxylated phosphate esters, the K-aryl ether phosphates, as well as the triethanolamine salts of polyaryl polyetherphosphate.

As crystallization habit modifier may also be used cationic surfactants such as octyl amine, triethanol amine, di(hydrogenated animal fat alkyl) dimethyl ammonium chloride, and non-ionic surfactants such as a variety of modified fatty alcohol ethoxylates. Among useful polymeric acids, salts, amides and alcohols may be mentioned the polyacrylic acids and polyacrylates, the acrylate-maleate copolymers, polyacrylamide, poly(2-ethyl-2-oxazoline), polyvinyl phosphonic acid, the copolymer of acrylic acid and allylhydroxypropyl sulfonate (AA-AHPS), poly-α-hydroxyacrylic acid (PHAS), polyvinyl alcohol, and poly(methyl vinyl ether—alt.-maleic acid).

Especially preferable crystallization habit modifiers are ethylene diamine succinic acid (EDDS), iminodisuccinic acid (ISA), ethylene diamine tetraacetic acid (EDTA), diethylene triamine pentaacetic acid (DTPA), nitrilotriacetic acid (NTA), N-bis-(2-(1,2-dicarboxyethoxy)ethyl aspartic acid (AES), the di-, tetra- and hexa-aminostilbenesulfonic acids and their salts such as Na-aminotriethoxy succinate (Na₆-TCA), as well as the alkylbenzenesulfonates.

In the process of the invention, the crystallization habit modifier is preferably used in an amount of 0.01 to 5.0%, most preferably 0.02-1.78%, based on the weight of the calcium sulfate hemihydrate and/or calcium sulfate anhydrite.

The method of the invention can be carried on by adding calcium sulfate hemihydrate and/or calcium sulfate anhydrite to the water or a mixture of the water and the crystallization habit modifier. In one embodiment of the invention, where water is contacted with calcium sulfate hemihydrate and/or calcium sulfate anhydrite the contact can be carried out without stopping or sequentially.

In contacting the calcium sulfate hemihydrate and/or calcium sulfate anhydrite, water and crystallization habit modifier are intermixed, preferably vigorously, until calcium sulfate hemihydrate and/or calcium sulfate anhydrite, water have reacted to form gypsum.

Because gypsum has a lower solubility in water than hemihydrate and anhydrite, the gypsum formed by the reaction of hemihydrate and/or anhydrite with water immediately tends to crystallize from the water medium. The recovered gypsum can be left in the water medium as a slurry or it can be recovered in dry form.

According to one embodiment of the invention, the crystallized and/or recovered gypsum is dispersed with a dispersing agent. Useful dispersing agents are the following: lignosulfonates such as Na lignosulfonate, condensation products of aromatic sulfonic acids with formaldehyde such as the condensed naphthalene sulfonates, dispersing anionic polymers, and copolymers made from anionic monomers or made anionic after polymerization, polymers containing repeating units having anionic charge such as carboxylic and sulfonic acids, their salts and combinations thereof. Also phosphates, non-ionic and cationic polymers, polysaccharides and surfactants may be used.

Among the anionic polymers described above are e.g. the poly(meth)acrylates, polyacrylate-maleate, polymaleate, poly-α-hydroxyacrylic acid, polyvinylsulfonate, polystyrene sulfonate, poly-2-acrylamide-2-methyl propane sulfonate and polyvinyl sulfonate.

A typical phosphate useful as dispersing agent is Na hexamethaphosphate. Typical non-ionic polymers are polyvinyl alcohol, polyvinyl pyrrolidone, the polyalkoxysilanes, and the polyethoxyalcohols. Cationically charged dispersing polymers are, for example, the dicyandiamide-formaldehyde polymers. Among polysaccharides should be mentioned native and modified starch, or modified cellulose such as carboxymethyl cellulose, and their derivatives.

Useful surfactants are anionic surfactants such as carboxylic acids, sulfonic acids sulfuric acid esters, phosphoric acids and polyphosphoric acid esters and their salts, non-ionic surface active substances such as ethoxylated alcohols, ethoxylated alkyl phenols, ethoxylated carboxylic acid esters and ethoxylated carboxylic acid amides, and cationic surface active substances such as acid-free amines, amines containing oxygen, amines containing an amide bond, and quaternary ammonium salts.

When dispersing gypsum, the amount of dispersing agent used is preferably from 0.01 to 5.0%, preferably from 0.05 to 3.0%, based on the weight of the gypsum.

If required, the gypsum product of the invention is also treated with other additives. A typical additive is a biocide which prevents the activity of micro organisms when storing and using the gypsum product.

Finally, the formed, recovered, dispersed and/or additive-treated gypsum product may be sieved or centrifuged in order to obtain gypsum particles having the desired size. A final bleaching step may also be included.

When using a calcium sulfate hemihydrate and/or calcium sulfate anhydrite and water in dry matter content of 50-84%, with or without a crystallization habit modifier, a new gypsum product is obtained. The new gypsum product is characterized in that it consists of essentially intact crystals having an average size (D₅₀) between 0.1 and below 2.0 μm (0.1≦D₅₀≦2.0). The size of the crystals obtained with prior art crystallization technique is usually considerably bigger.

By essentially intact crystals is meant crystal particles which are not mechanically broken, but the crystal surfaces of which are preserved. For example, FIG. 33 shows gypsum with broken particles, obtained by grinding, whereas FIGS. 23 to 27 and 30 show gypsum having intact crystals, prepared by crystallization according to embodiments of the invention. Preferred crystal sizes range from 0.2 to below 2.0 μm.

The shape ratio SR of the crystals of the claimed gypsum product is preferably at least 2.0, more preferably between 2.0 and 50, most preferably between 3.0 and 40. The aspect ratio AS of the crystals is preferably between 1.0 and 10, most preferably between 1.0 and below 5.0.

The narrower the width of the particle size distribution WPDS=(D₇₅−D₂₅)/D₅₀ is the more homogenic the gypsum product is. A homogenic product has, in addition to high scattering, also an improved opacity. For the gypsum product of this invention the width of the particle size distribution is preferably below 2.0, more preferably below 1.25, most preferably below 1.10, which ensures that the product is homogeneous. FIG. 33 shows that a ground product according to the state of the art has particles of very different sizes (broad size distribution).

When the above mentioned criteria are fulfilled, a gypsum product is obtained giving high opacity and gloss.

As was stated before, the gypsum product of the invention is typically a coating or a filler pigment. In one embodiment of the invention the gypsum product is a coating pigment consisting of crystals having an average size of 0.1-1.0 μm, preferably an average size of 0.5-1.0 μm. In another embodiment the gypsum product is a filler pigment consisting of crystals having an average size of 1.0-2.0 μm.

On the following a few examples of the process of the invention and the product obtained by using the process of the invention are presented. The mere purpose of these examples is to illuminate the invention.

### FIGURES

FIGS. 1-22 present the electron microscope photographs of the gypsum products of examples 1-22 taken with a scanning electron microscope. Pictures 23-27 present photographs from the gypsum products of examples 23-27 taken with a microscope. Please see also the explanation of the examples later in the text. In FIGS. 28-32 are shown results from the application of platy calcium sulfate pigments according to the invention in the coating and filling application of paper.

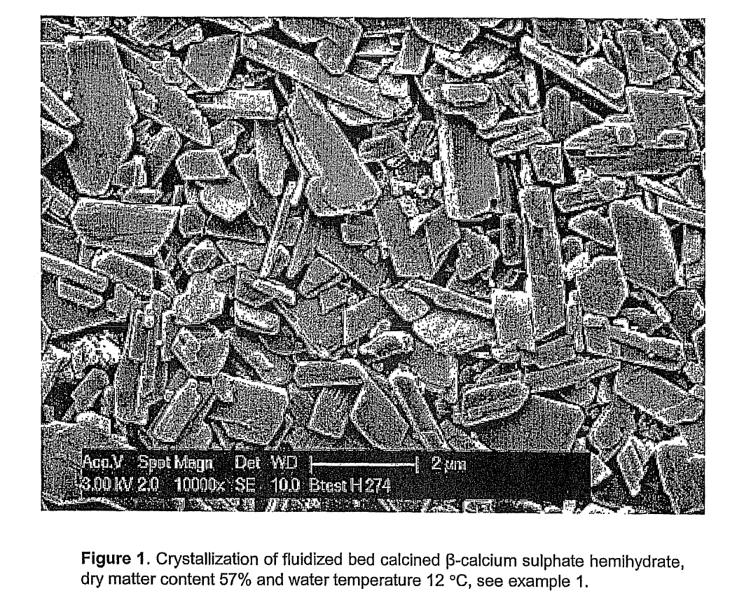

In FIGS. 1-5 are shown electron microscope micrographs of the crystallized gypsum products obtained in examples 1-5 with fluidized bed calcined β-calcium sulfate hemihydrate in different dry matter contents and temperatures.

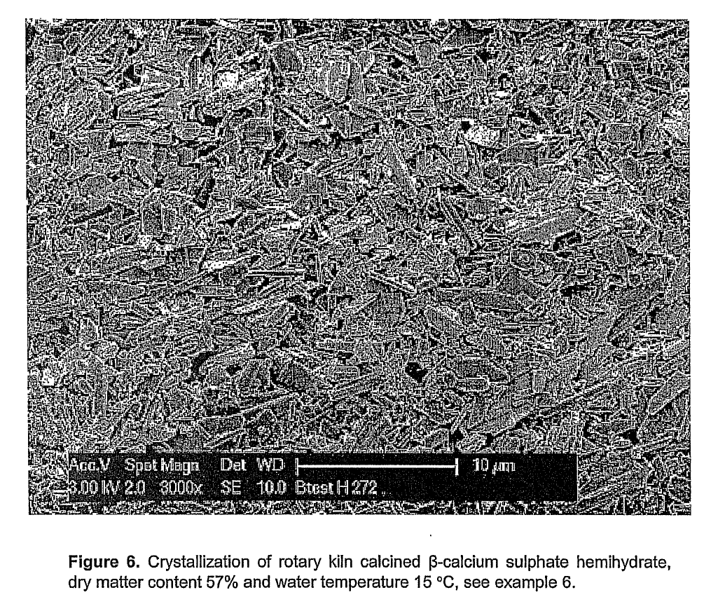

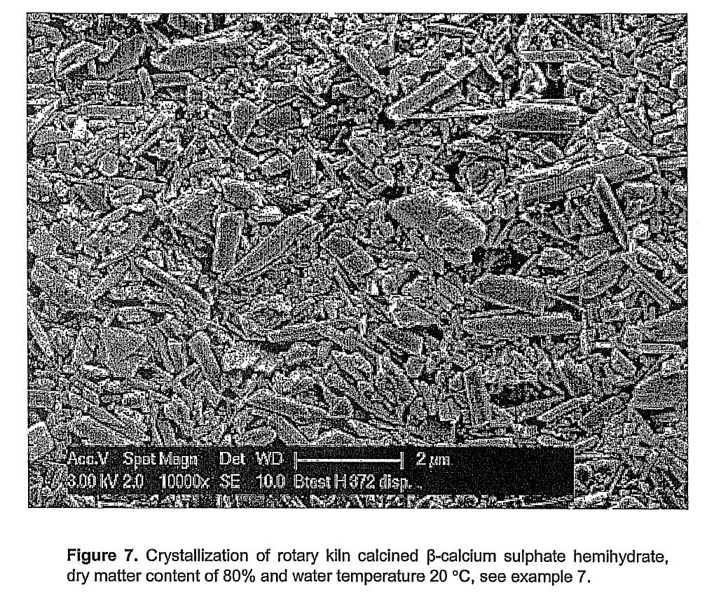

In FIGS. 6 and 7 are shown electron microscope micrographs of the crystallized gypsum products obtained in examples 6 and 7 with rotary kiln calcined β-calcium sulfate hemihydrate in different dry matter contents and temperatures.

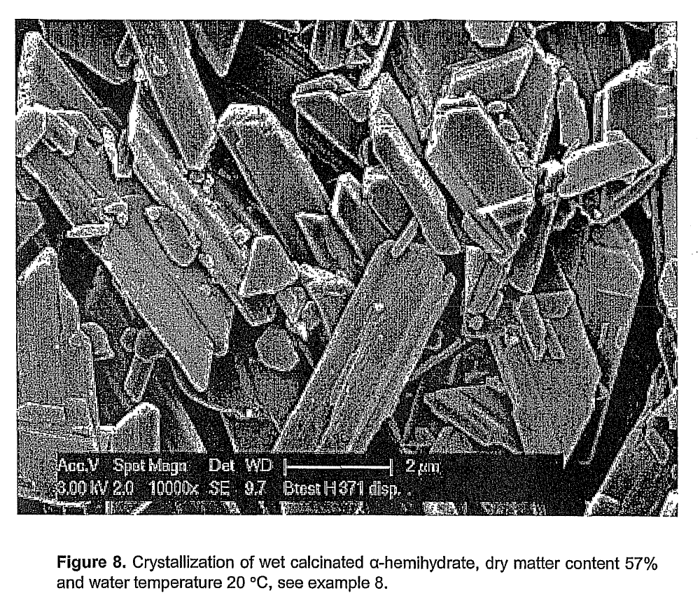

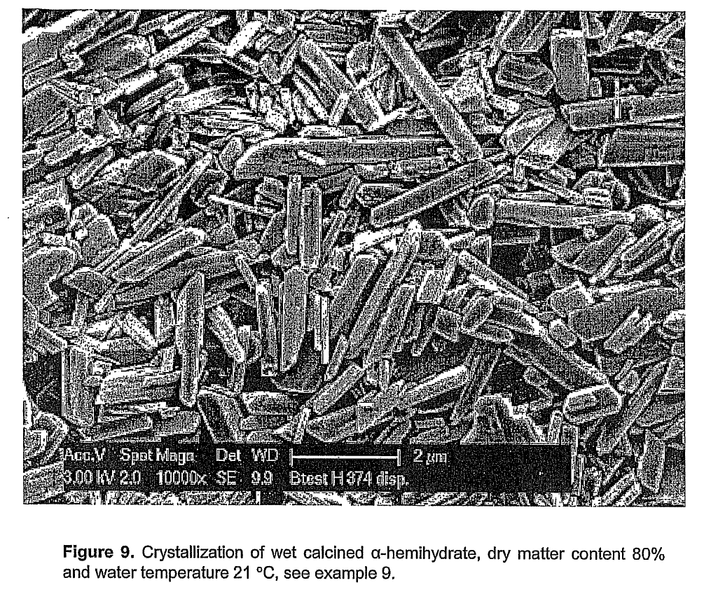

In FIGS. 8 and 9 are shown electron microscope micrographs of the crystallized gypsum products obtained in examples 8 and 9 with wet calcined α-calcium sulfate hemihydrate in different dry matter contents and temperatures.

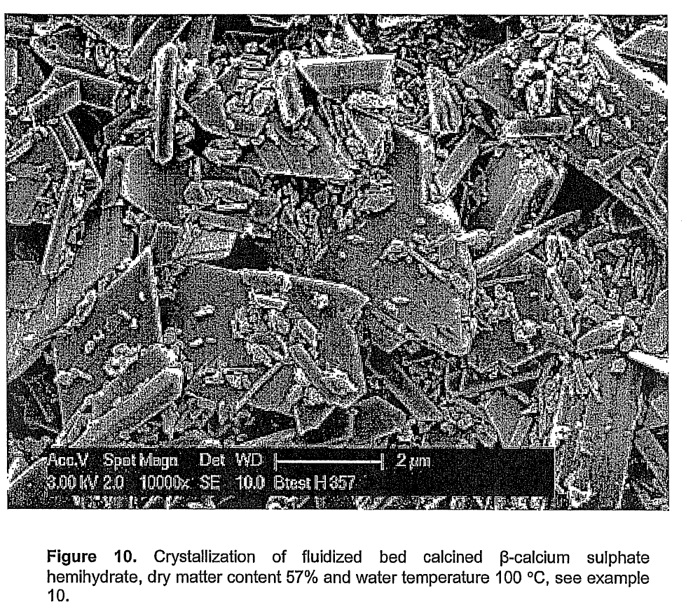

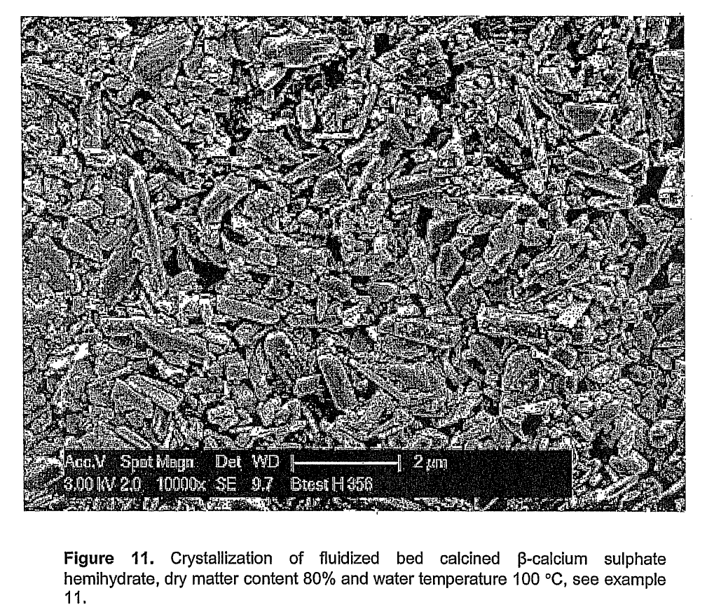

In FIGS. 10-12 are shown electron microscope micrographs of the crystallized gypsum products obtained in examples 10-12 with fluidized bed calcined β-calcium sulfate hemihydrate in different dry matter contents and reaction conditions (temperature, pH)

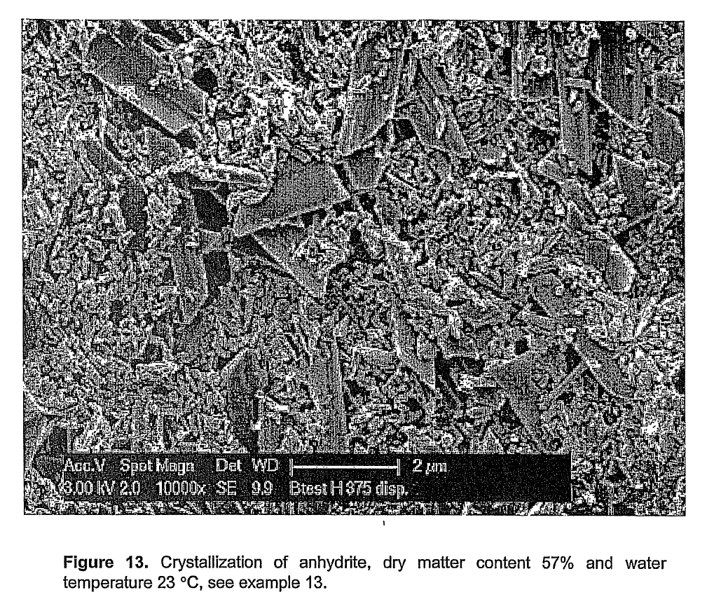

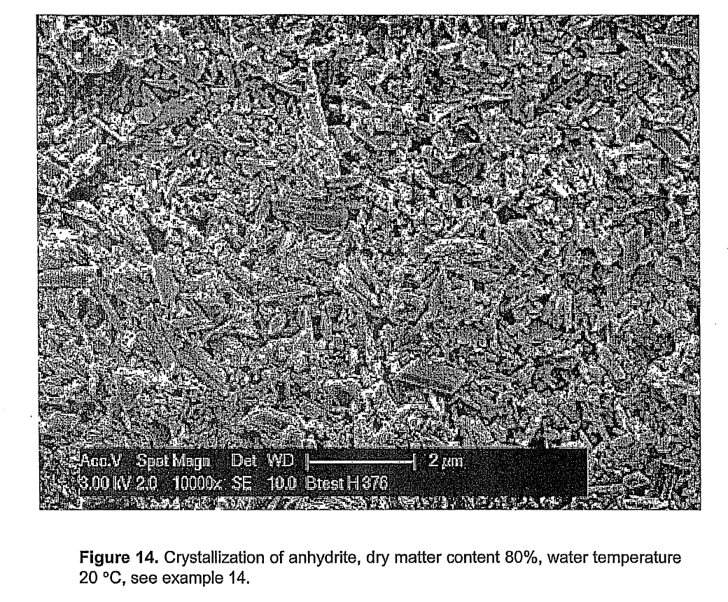

In FIGS. 13 and 14 are shown electron microscope micrographs of the crystallized gypsum products obtained in examples 13 and 14 with calcium sulfate anhydrite in different dry matter contents and temperatures.

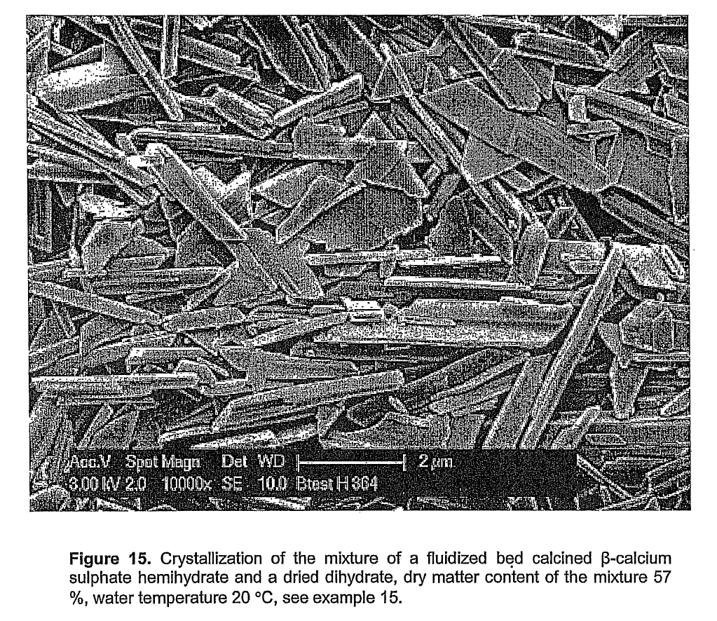

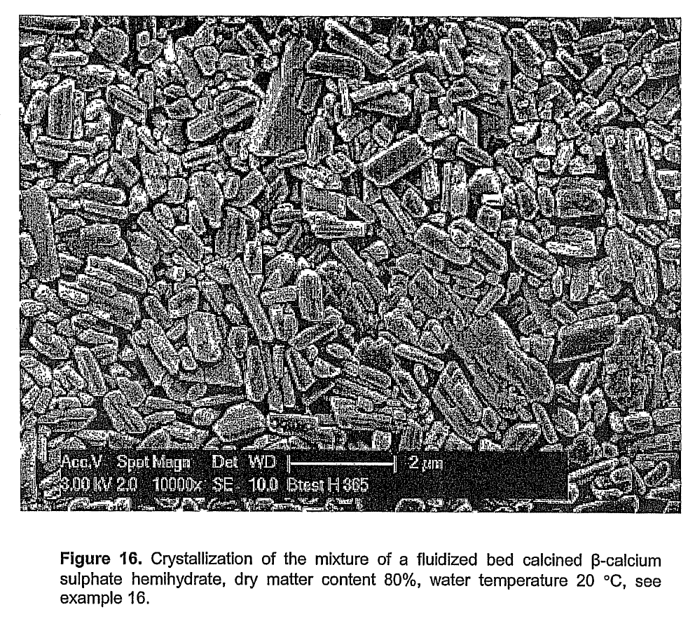

In FIGS. 15 and 16 are shown electron microscope micrographs of the crystallized gypsum products obtained in examples 15 and 16 with a mixture of calcined β-calcium sulfate hemihydrate and dried calcium sulfate dihydrate in different dry matter contents.

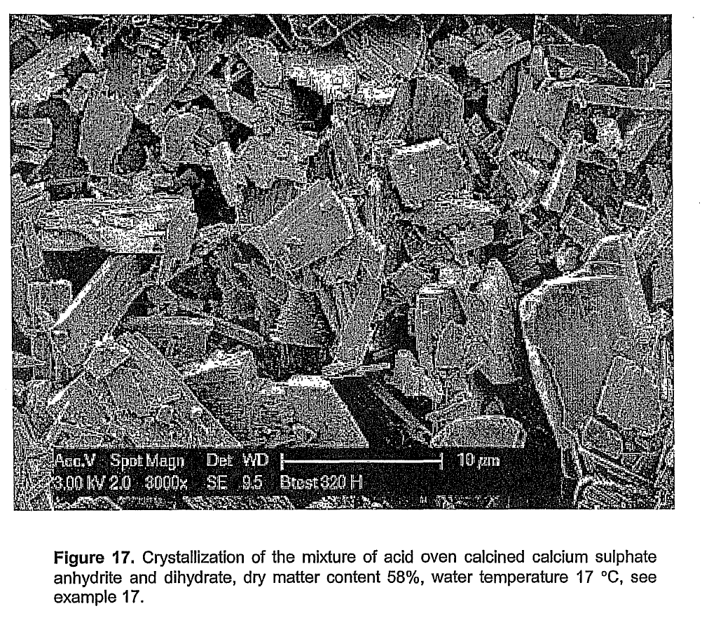

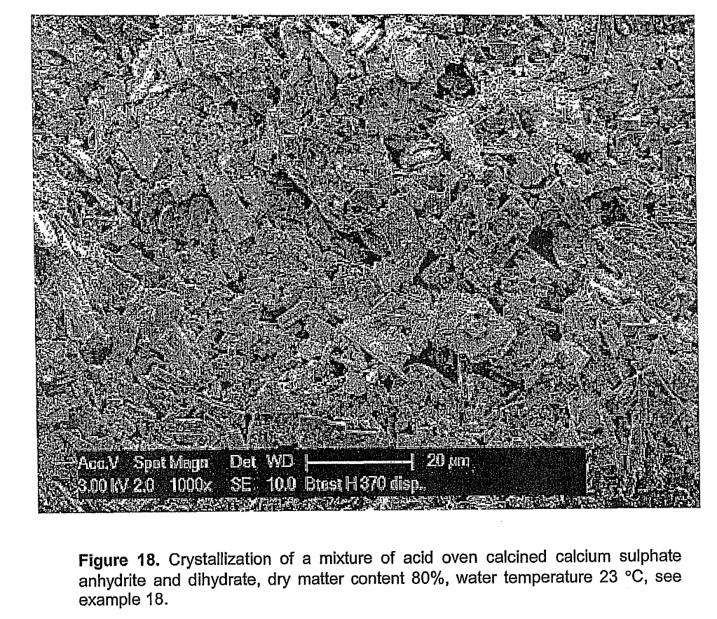

In FIGS. 17 and 18 are shown electron microscope micrographs of the crystallized gypsum products obtained in examples 17 and 18 with a mixture of acid oven calcined calcium sulfate anhydrite and calcium sulfate dihydrate in different dry matter contents and temperatures.

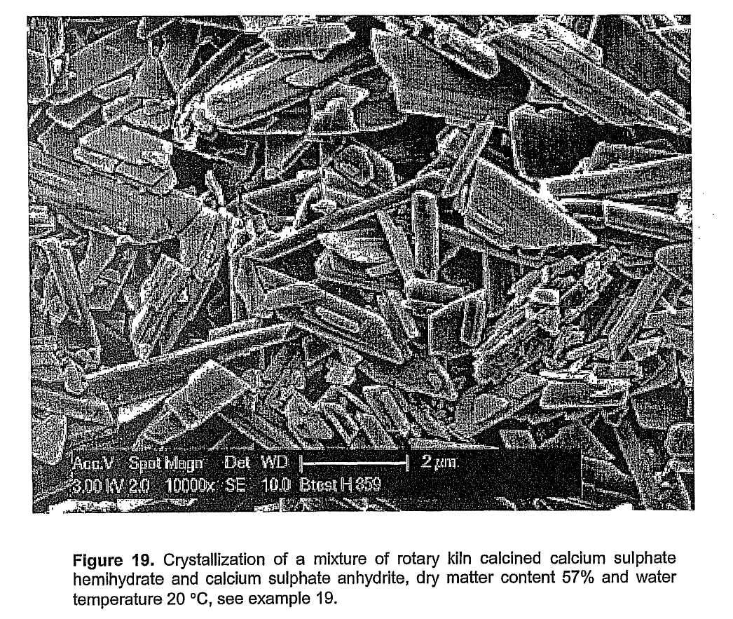

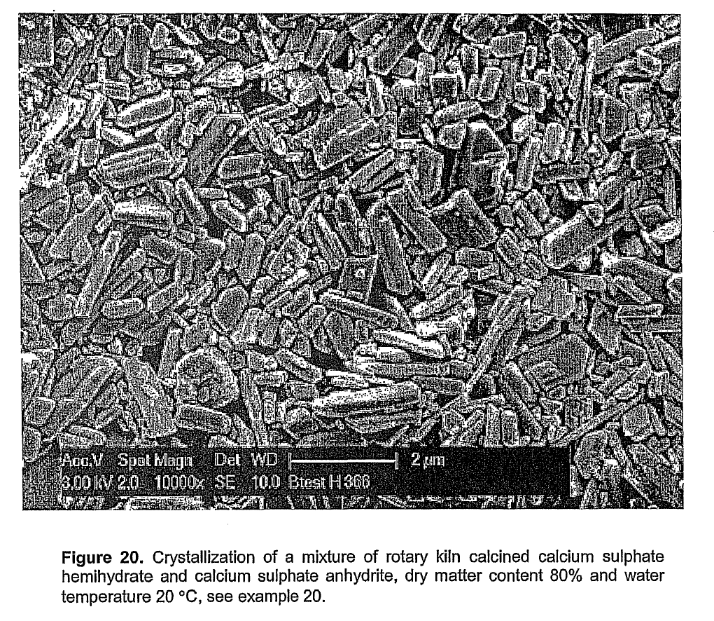

In FIGS. 19 and 20 are shown electron microscope micrographs of the crystallized gypsum products obtained in examples 19 and 20 with a mixture of rotary kiln calcined β-calcium sulfate hemihydrate and calcium sulfate anhydrite in different dry matter contents.

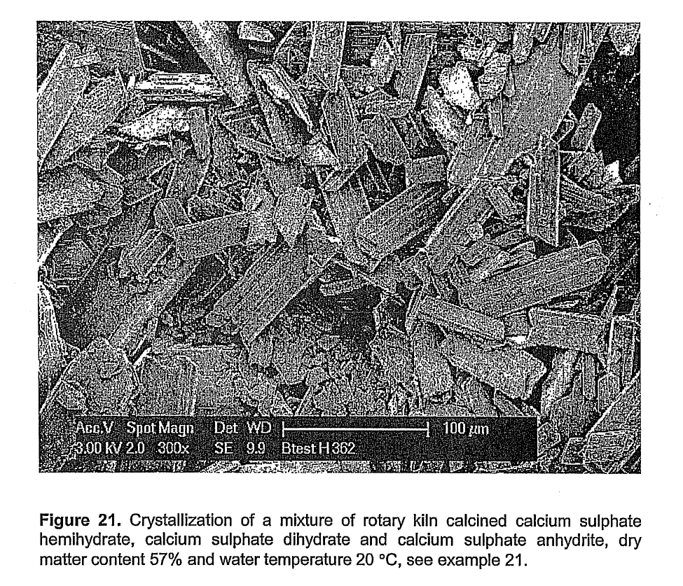

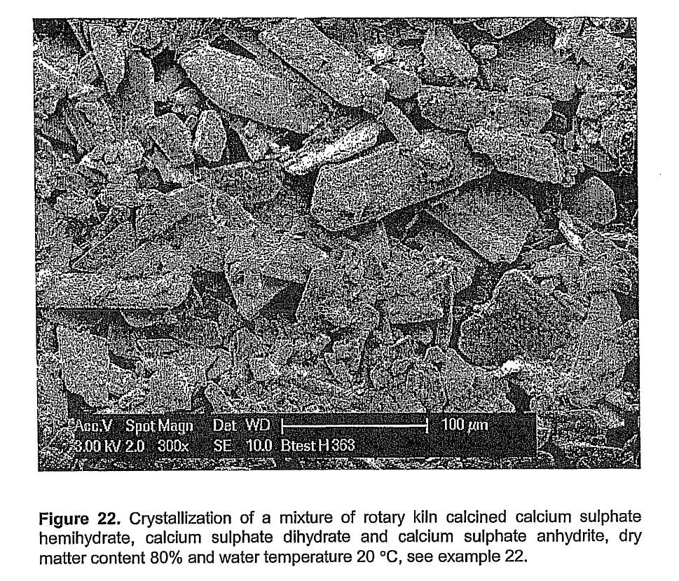

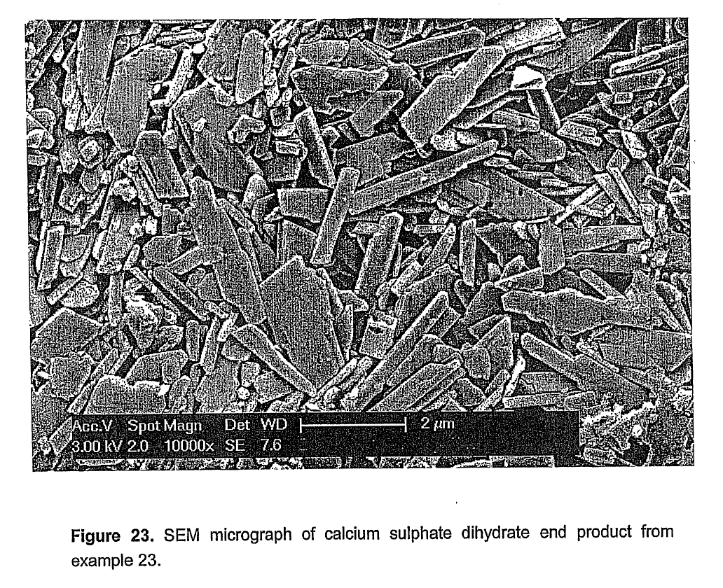

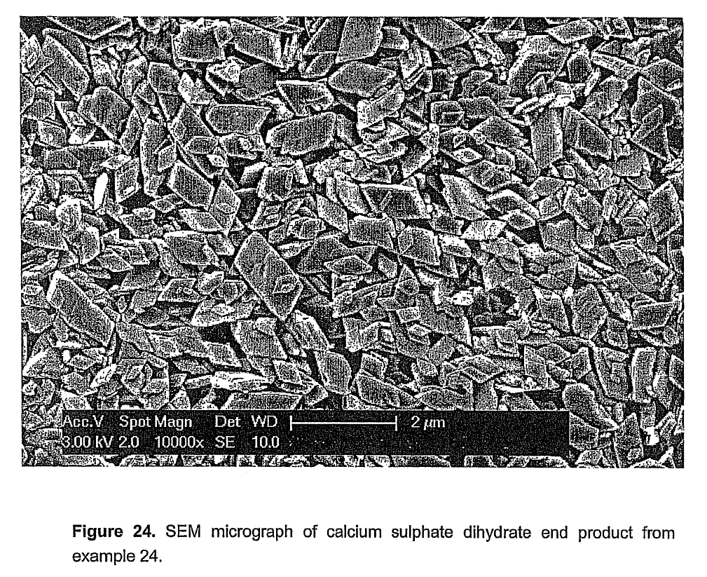

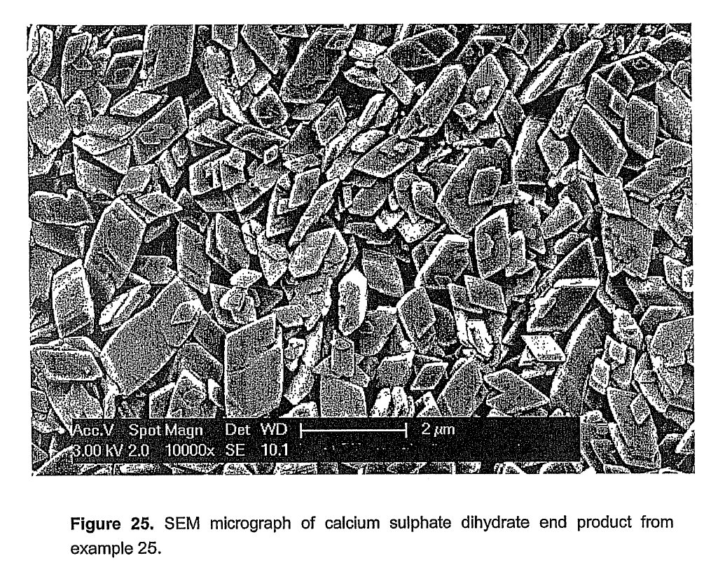

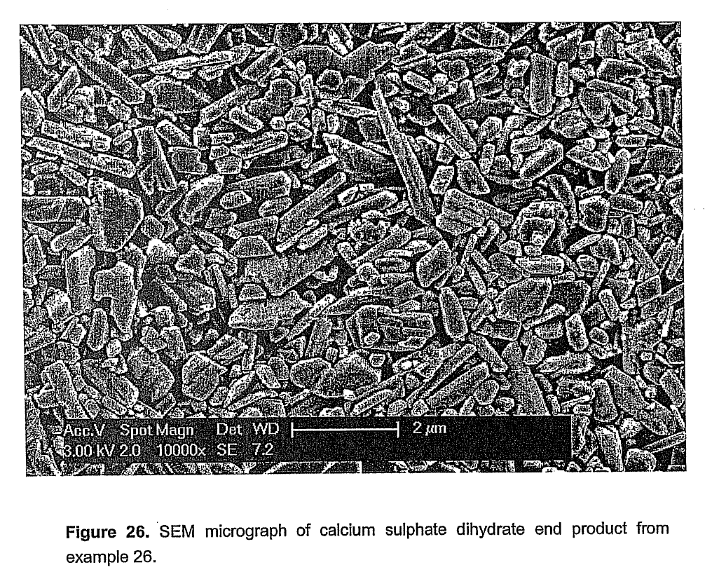

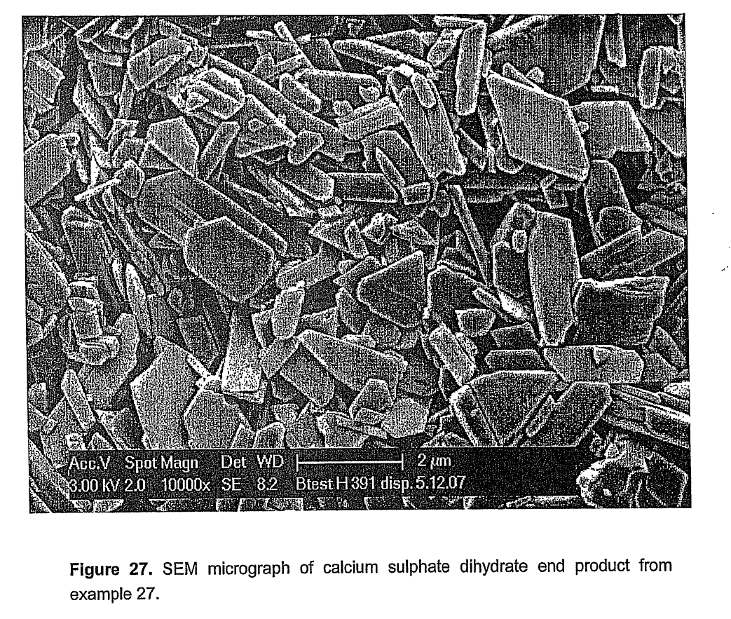

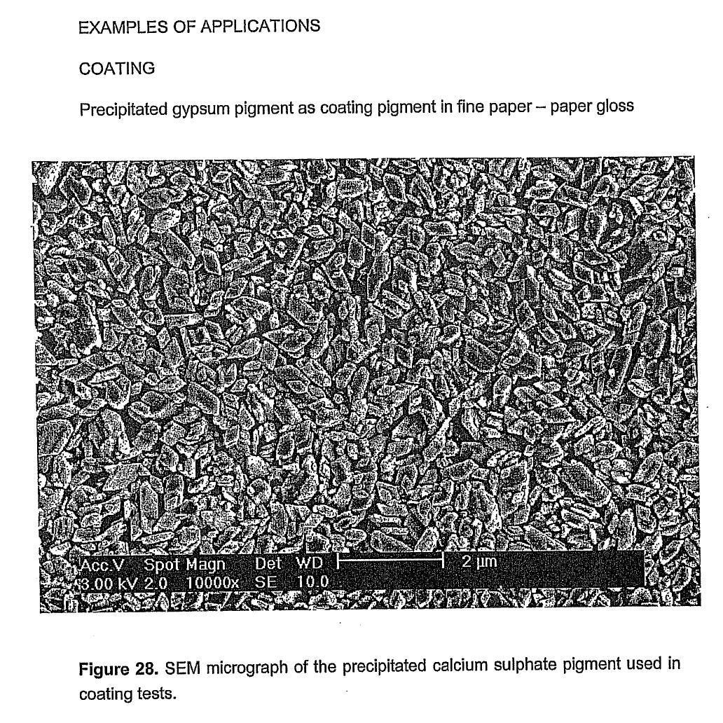

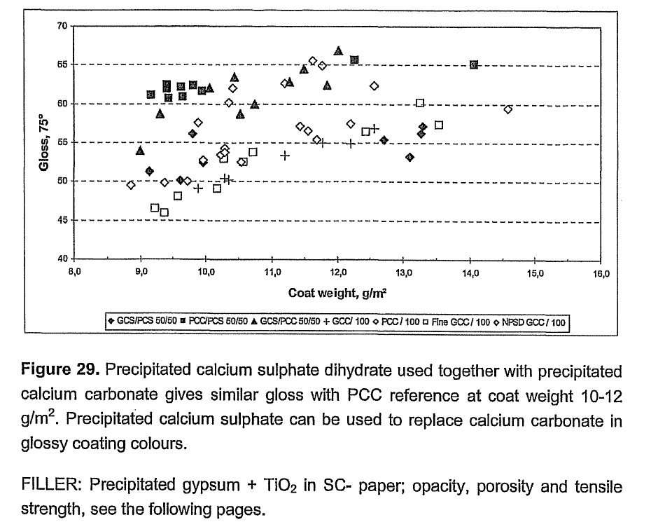

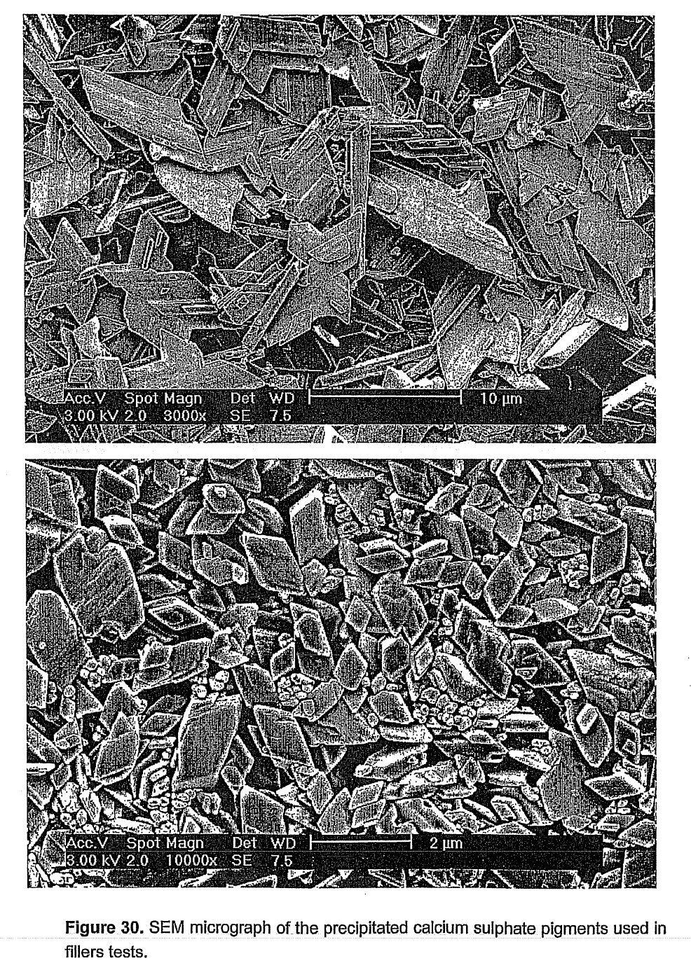

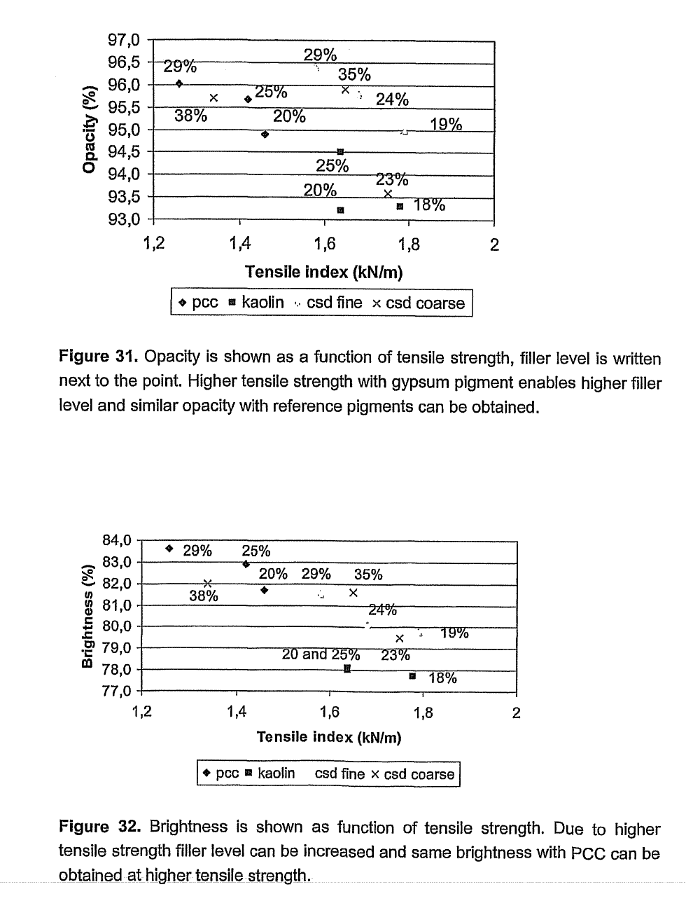

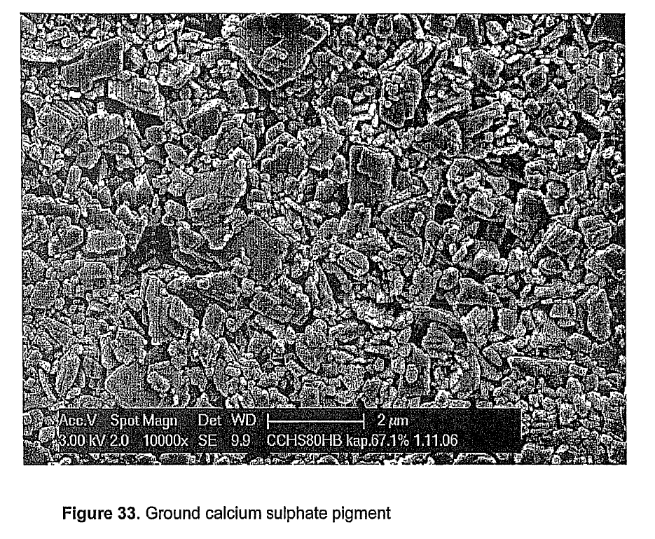

In FIG. 21 and 22 are shown electron microscope micrographs of the crystallized gypsum products obtained in example 21 with a mixture of rotary kiln calcined β-calcium sulfate hemihydrate, calcium sulfate dihydrate and calcium sulfate anhydrite in different dry matter contents.

In FIGS. 23-27 are shown electron microscope micrographs of calcium sulfate dihydrate products of examples 23-27. See also the summaries of the examples.

In FIGS. 28-33 are shown examples of the application of platy calcium sulfate pigments according to the invention in the coating and filling application of paper.

In FIG. 28 is shown an electron microscope image of the precipitated calcium sulfate pigment used in coating tests of wood free fine paper. The studied property was paper gloss.

In FIG. 29 is shown gloss results using precipitated calcium sulfate dihydrate together with precipitated calcium carbonate and compared with a reference. It can be seen that with coat weight of 10 g/m² combination of calcium sulfate dihydrate and PCC gives comparable gloss to PCC reference. Thus precipitated gypsum can be used to replace calcium carbonate in glossy coating colors.

In FIG. 30 is shown an electron microscope image of the precipitated calcium sulfate pigment used in SC-paper filler tests. The studied properties were opacity, porosity and tensile strength of paper.

In FIG. 31 is shown the opacity as a function of tensile strength in filler application. Precipitated gypsum pigment was used together with titanium dioxide. Higher tensile strength with gypsum pigment enables increased filler level and similar opacity with reference pigments.

In FIG. 32 is shown the brightness as a function of tensile strength in filler application. Precipitated gypsum pigment was used together with titanium dioxide. Higher tensile strength with gypsum pigment enables increased filler level. Similar brightness with PCC can be obtained at higher tensile strength.

In FIG. 33 is shown an electron microscope image of ground calcium sulfate dihydrate pigment according to the state of the art.

### EXAMPLES 1-22

### Without a Crystallization Habit Modifier

### Synthesis

General information is first presented. A method optimization for a coating pigment was carried out. The parameters were:

Tw (water temperature) (° C.) 12-100

HH (hemihydrate) (w-%) 57-84

The reaction was carried out either at system pH or the pH was adjusted to the desired value by addition of small amounts of 10% NaOH or 10% H₂SO₄.

The reactions are carried out in an unjacketed reactor, the temperature of the water being 12-100° C. The hemihydrate/anhydrite is added as batch to the water resulting a slurry with an initial solids content of 57-84 w-%. The slurry is stirred using a Hobart-mixer model N50CE (ca. 250-500 rpm).

### Analysis

The pH of the reactor was monitored by a Knick Portamess 911 pH-electrode. The morphology of calcium sulfate dihydrate was studied by using a FEI XL 30 FEG scanning electron microscope. Conversion of the hemihydrate to dihydrate gypsum was analyzed using a Mettler Toledo TGA/SDTA85 1/1100-thermogravimetric analyzer (TG). The crystal structure was determined with Philips X'pert x-ray powder diffractometer (XRD).

Particle size and distribution were studied using a Sedigraph 5100 particle sizer. The samples were prepared in methanol.

Sample preparation: 2 g of gypsum (dry matter content of which is approximately 68%) is weighted in a decanter, 50 ml of methanol is added (e.g. J. T. Baker 8045). The mixture is stirred with a magnetic stirrer utilizing ultrasound for 10 min.

Determination of base line: 1000 g of methanol (e.g. J. T. Baker 8045) and 13.4 g of water is mixed. Properties of the liquid are as follows:

| T° C. | Density g/cm³ | Viscosity cp |
|---|---|---|
| 30 | 0.7953 | 0.5300 |
| 35 | 0.7892 | 0.5040 |
| 40 | 0.7831 | 0.4760 |

Density of the sample: the density of dihydrate gypsum, 2.3 g/cm³ was used

Type of analysis: High speed

Analysis of morphology by micrographs

The lengths/diameters and thickness as defined in the description were measured from scanning electron microscope photographs for at least 20 particles.

### Example 1

1. 645 g of water is placed in a reactor. The water temperature is 12° C.

2. Fluidized bed calcined β-calcium sulfate hemihydrate is evenly added to the reactor with the operation speed of the stirrer set to position 1. The total amount of hemihydrate added is 855.0 g. After the addition the operation speed of the stirrer is raised to position 2.

3. Wait for the formation of calcium sulfate dihydrate.

4. The precipitated product is dispersed using a Diaf dissolver and Fennodispo A41 polyacrylate dispersant.

5. Other chemicals like biocide (Fennosan IT 21) are added.

6. Possible whitening treatment, grinding to crush the agglomerates and screening.

The obtained dihydrate gypsum is shown in FIG. 1.

Average particle size (D50) is 0.90 μm

The shape ratio is 9.18

The aspect ratio is 3.27

Width of the particle size distribution is 0.73

### Example 2

1. 480 g of water is added in a reactor. The temperature of the water is 23° C.

2. Fluidized bed calcined β-calcium sulfate hemihydrate is evenly added to the reactor with the operation speed of the stirrer set to position 1. The total amount of hemihydrate added is 720.0 g. After the addition the operation speed of the stirrer is raised to position 2.

3. Wait for the formation of calcium sulfate dihydrate.

4. The precipitated product is dispersed using a Diaf dissolver and Fennodispo A41 polyacrylate dispersant.

5. Other chemicals like biocide (Fennosan IT 21) are added.

6. Possible whitening treatment, grinding to crush the agglomerates and screening.

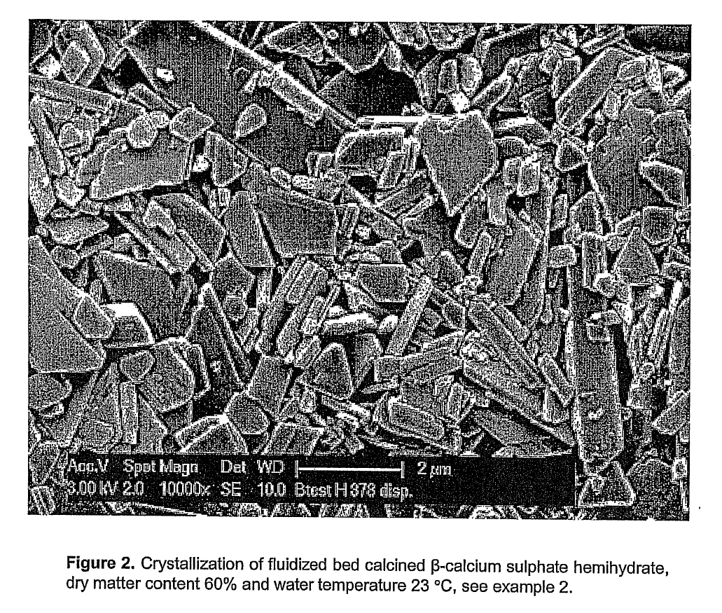

The obtained dihydrate gypsum is shown in FIG. 2.

Average particle size (D50) is 1.13 μm

The shape ratio is 7.03

The aspect ratio is 2.55

Width of the particle size distribution is 0.91

### Example 3

1. 360 g of water is added in a reactor. The temperature of the water is 23° C.

2. Fluidized bed calcined β-calcium sulfate hemihydrate is evenly added to the reactor with the operation speed of the stirrer set to position 1. The total amount of hemihydrate added is 840.0 g. After the addition the operation speed of the stirrer is raised to position 2.

3. Wait for the formation of calcium sulfate dihydrate.

4. The precipitated product is dispersed using a Diaf dissolver and Fennodispo A41 polyacrylate dispersant.

5. Other chemicals like biocide (Fennosan IT 21) are added.

6. Possible whitening treatment, grinding to crush the agglomerates and screening.

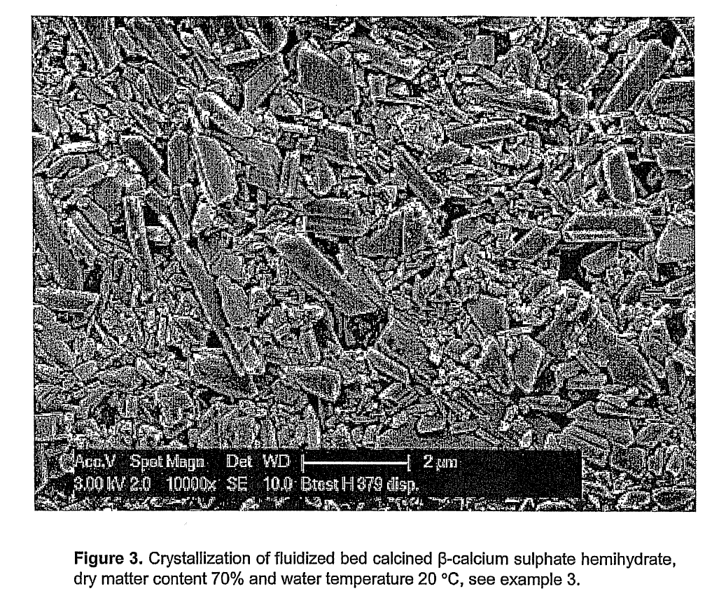

The obtained dihydrate gypsum is shown in FIG. 3.

Average particle size (D50) is 1.13 μm

The shape ratio is 6.46

The aspect ratio is 3.06

Width of the particle size distribution is 1.45

### Example 4

1. 300 g of water is added in a reactor. The temperature of the water is 20° C.

2. Fluidized bed calcined β-calcium sulfate hemihydrate is evenly added to the reactor with the operation speed of the stirrer set to position 1. The total amount of hemihydrate added is 1200 g. After the addition the operation speed of the stirrer is raised to position 2.

3. Wait for the formation of calcium sulfate dihydrate.

4. The precipitated product is dispersed using a Diaf dissolver and Fennodispo A41 polyacrylate dispersant.

5. Other chemicals like biocide (Fennosan IT 21) are added.

6. Possible whitening treatment, grinding to crush the agglomerates and screening.

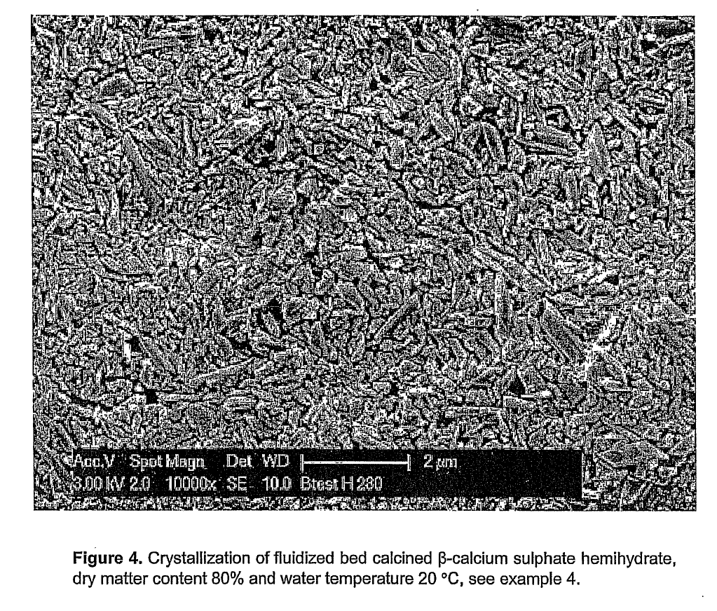

The obtained dihydrate gypsum is shown in FIG. 4.

Average particle size (D50) is 0.81 μm

The shape ratio is 3.18

The aspect ratio is 3.18

Width of the particle size distribution is 2.54

### Example 5

1. 192 g of water is added in a reactor. The temperature of the water is 20° C.

2. Fluidized bed calcined β-calcium sulfate hemihydrate is evenly added to the reactor with the operation speed of the stirrer set to position 1. The total amount of hemihydrate added is 1008 g. After the addition the operation speed of the stirrer is raised to position 2.

3. Wait for the formation of calcium sulfate dihydrate.

4. The precipitated product is dispersed using a Diaf dissolver and Fennodispo A41 polyacrylate dispersant.

5. Other chemicals like biocide (Fennosan IT 21) are added.

6. Possible whitening treatment, grinding to crush the agglomerates and screening.

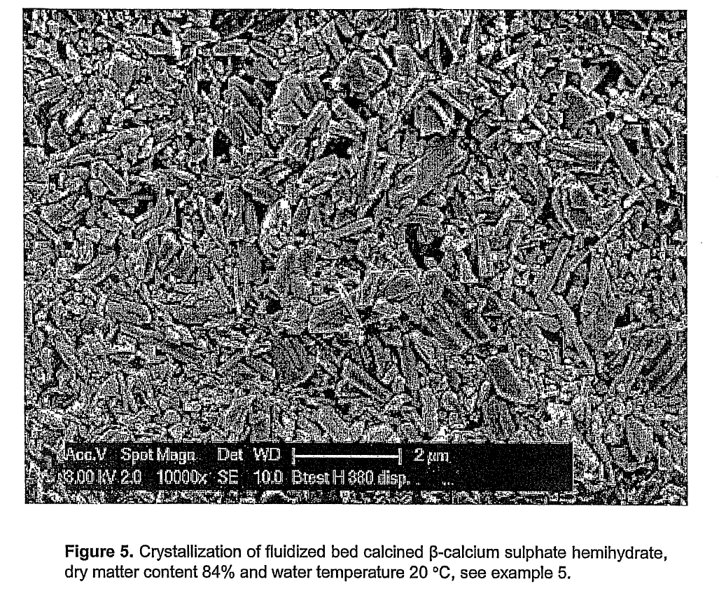

The obtained dihydrate gypsum is shown in FIG. 5.

Average particle size (D50) is 0.97 μm

The shape ratio is 4.11

The aspect ratio is 4.11

Width of the particle size distribution is 3.68

### Example 6

1. 645 g of water is added in a reactor. The temperature of the water is 15° C.

2. Rotary kiln calcined β-calcium sulfate hemihydrate is evenly added to the reactor with the operation speed of the stirrer being set to position 1. The total amount of hemihydrate added is 855.0 g. The rotation speed of the stirrer is raised to position 2 after the addition of sulfate hemihydrate.

3. Wait for the formation of calcium sulfate dihydrate.

4. The precipitated product is dispersed using a Diaf dissolver and Fennodispo A41 polyacrylate dispersant.

5. Other chemicals like biocide (Fennosan IT 21) are added.

6. Possible whitening treatment, grinding to crush the agglomerates and screening.

The obtained dihydrate gypsum is shown in FIG. 6.

Average particle size (D50) is 1.04 μm

The shape ratio is 10.48

The aspect ratio is 3.30

Width of the particle size distribution is 1.09

### Example 7

1. 300 g of water is added in a reactor. The temperature of the water is 20° C.

2. Rotary kiln calcined β-calcium sulfate hemihydrate is evenly added to the reactor with the operation speed of the stirrer being set to position 1. The total amount of hemihydrate added is 1200.0 g. The rotation speed of the stirrer is raised to position 2 after the addition of sulfate hemihydrate.

3. Wait for the formation of calcium sulfate dihydrate.

4. The precipitated product is dispersed using a Diaf dissolver and Fennodispo A41 polyacrylate dispersant.

5. Other chemicals like biocide (Fennosan IT 21) are added.

6. Possible whitening treatment, grinding to crush the agglomerates and screening.

The obtained dihydrate gypsum is shown in FIG. 7.

Average particle size (D50) is 0.91 μm

The shape ratio is 6.64

The aspect ratio is 4.41

Width of the particle size distribution is 2.08

### Example 8

1. 528 g of water is added in a reactor. The water temperature is 20° C.

2. Wet calcined α-calcium sulfate hemihydrate is evenly added to the reactor with the operation speed of the stirrer being set to position 1. The total amount of hemihydrate added is 700 g. The rotation speed of the stirrer is raised to position 2 after the addition of sulfate hemihydrate.

3. Wait for the formation of calcium sulfate dihydrate.

4. The precipitated product is dispersed using a Diaf dissolver and Fennodispo A41 polyacrylate dispersant.

5. Other chemicals like biocide (Fennosan IT 21) are added.

6. Possible whitening treatment, grinding to crush the agglomerates and screening.

The obtained dihydrate gypsum is shown in FIG. 8.

Average particle size (D50) is 2.43 μm

The shape ratio is 6.96

The aspect ratio is 3.37

Width of the particle size distribution is 0.77

### Example 9

1. 128 g of water is placed in a reactor. The water temperature is 20° C.

2. Wet calcined α-calcium sulfate hemihydrate is evenly added to the reactor with the operation speed of the stirrer being set to position 1. The total amount of hemihydrate added is 512 g. The rotation speed of the stirrer is raised to position 2 after the addition of sulfate hemihydrate.

3. Wait for the formation of calcium sulfate dihydrate.

4. The precipitated product is dispersed using a Diaf dissolver and Fennodispo A41 polyacrylate dispersant.

5. Other chemicals like biocide (Fennosan IT 21) are added.

6. Possible whitening treatment, grinding to crush the agglomerates and screening.

The obtained dihydrate gypsum is shown in FIG. 9.

Average particle size (D50) is 1.09 μm

The shape ratio is 5.27

The aspect ratio is 5.27

Width of the particle size distribution is 0.88

### Example 10

1. 645 g of water is placed in a reactor. The water temperature is 100° C.

2. Fluidized bed calcined β-calcium sulfate hemihydrate is evenly added to the reactor with the operation speed of the stirrer set to position 1. The total amount of hemihydrate added is 855.0 g. After the addition the operation speed of the stirrer is raised to position 2.

3. Wait for the formation of calcium sulfate dihydrate.

4. The precipitated product is dispersed using a Diaf dissolver and Fennodispo A41 polyacrylate dispersant.

5. Other chemicals like biocide (Fennosan IT 21) are added.

6. Possible whitening treatment, grinding to crush the agglomerates and screening.

The obtained dihydrate gypsum is shown in FIG. 10.

Average particle size (D50) is 3.18 μm

The shape ratio is 7.89

The aspect ratio is 3.69

Width of the particle size distribution is 1.17

### Example 11

1. 300 g of water is placed in a reactor. The water temperature is 100° C.

2. Fluidized bed calcined β-calcium sulfate hemihydrate is evenly added to the reactor with the operation speed of the stirrer set to position 1. The total amount of hemihydrate added is 1200 g. After the addition the operation speed of the stirrer is raised to position 2.

3. Wait for the formation of calcium sulfate dihydrate.

4. The precipitated product is dispersed using a Diaf dissolver and Fennodispo A41 polyacrylate dispersant.

5. Other chemicals like biocide (Fennosan IT 21) are added.

6. Possible whitening treatment, grinding to crush the agglomerates and screening.

The obtained dihydrate gypsum is shown in FIG. 11.

Average particle size (D50) is 1.19 μm

The shape ratio is 5.28

The aspect ratio is 2.95

Width of the particle size distribution is 1.98

### Example 12

1. 645 g of water is placed in a reactor. The water temperature is 17° C. and pH is adjusted to 2.

2. Fluidized bed calcined β-calcium sulfate hemihydrate is evenly added to the reactor with the operation speed of the stirrer set to position 1. The total amount of hemihydrate added is 855 g. After the addition the operation speed of the stirrer is raised to position 2.

3. Wait for the formation of calcium sulfate dihydrate.

4. The precipitated product is dispersed using a Diaf dissolver and Fennodispo A41 polyacrylate dispersant.

5. Other chemicals like biocide (Fennosan IT 21) are added.

6. Possible whitening treatment, grinding to crush the agglomerates and screening.

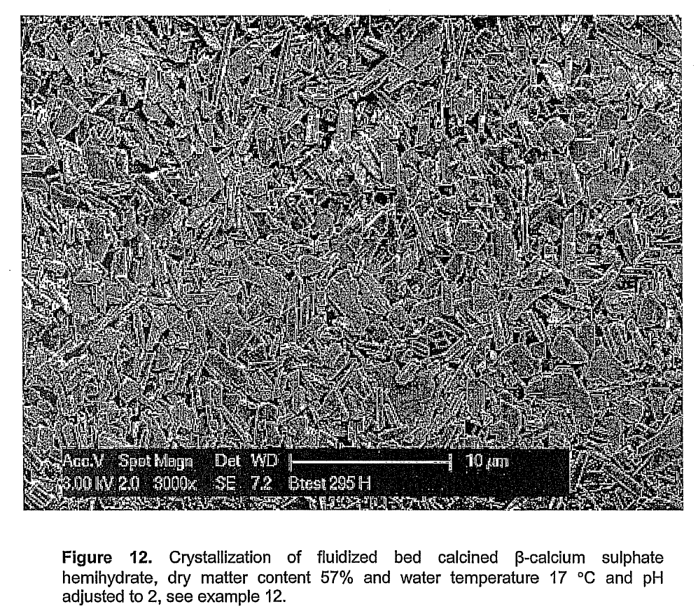

The obtained dihydrate gypsum is shown in FIG. 12.

Average particle size (D50) is 1.06 μm

The shape ratio is 14.22

The aspect ratio is 4.40

Width of the particle size distribution is 0.99

### Example 13

1. 528 g of water is placed in a reactor. The water temperature is 23° C.

2. Form II/III calcium sulfate anhydrite is evenly added to the reactor with the operation speed of the stirrer being set to position 1. The total amount of anhydrite added is 700 g. After the addition the operation speed of the stirrer is raised to position 2.

3. Wait for the formation of calcium sulfate dihydrate.

4. The precipitated product is dispersed using a Diaf dissolver and Fennodispo A41 polyacrylate dispersant.

5. Other chemicals like biocide (Fennosan IT 21) are added.

6. Possible whitening treatment, grinding to crush the agglomerates and screening.

The obtained dihydrate gypsum is shown in FIG. 13.

Average particle size (D50) is 0.89 μm

The shape ratio is 7.82

The aspect ratio is 3.61

Width of the particle size distribution is 1.34

### Example 14

1. 200 g of water is placed in a reactor. The water temperature is 20° C.

2. Form II/III calcium sulfate anhydrite is evenly added to the reactor with the operation speed of the stirrer being set to position 1. The total amount of anhydrite added is 800 g. After the addition the operation speed of the stirrer is raised to position 2.

3. Wait for the formation of calcium sulfate dihydrate.

4. The precipitated product is dispersed using a Diaf dissolver and Fennodispo A41 polyacrylate dispersant.

5. Other chemicals like biocide (Fennosan IT 21) are added.

6. Possible whitening treatment, grinding to crush the agglomerates and screening.

The obtained dihydrate gypsum is shown in FIG. 14.

Average particle size (D50) is 0.61 μm

The shape ratio is 5.77

The aspect ratio is 2.90

Width of the particle size distribution is 1.84

### Example 15

1. 513 g of water is placed in a reactor. The water temperature is 20° C.

2. A mixture (50:50) of calcium sulfate hemihydrate and calcium sulfate dihydrate is evenly added to the reactor with the operation speed of the stirrer being set to position 1. The total amount of hemihydrate and dihydrate added is 800 g. After the addition the operation speed of the stirrer is raised to position 2.

3. Wait for the formation of calcium sulfate dihydrate.

4. The precipitated product is dispersed using a Diaf dissolver and Fennodispo A41 polyacrylate dispersant.

5. Other chemicals like biocide (Fennosan IT 21) are added.

6. Possible whitening treatment, grinding to crush the agglomerates and screening.

The obtained dihydrate gypsum is shown in FIG. 15.

Average particle size (D50) is 0.85 μm

The shape ratio is 15.12

The aspect ratio is 4.79

Width of the particle size distribution is 7.22

### Example 16

1. 250 g of water is placed in a reactor. The water temperature is 20° C.

2. A mixture (50:50) of calcium sulfate hemihydrate and calcium sulfate dihydrate is evenly added to the reactor with the operation speed of the stirrer being set to position 1. The total amount of hemihydrate and dihydrate added is 1000 g. After the addition the operation speed of the stirrer is raised to position 2.

3. Wait for the formation of calcium sulfate dihydrate.

4. The precipitated product is dispersed using a Diaf dissolver and Fennodispo A41 polyacrylate dispersant.

5. Other chemicals like biocide (Fennosan IT 21) are added.

6. Possible whitening treatment, grinding to crush the agglomerates and screening.

The obtained dihydrate gypsum is shown in FIG. 16.

Average particle size (D50) is 2.02 μm

The shape ratio is 3.36

The aspect ratio is 3.36

Width of the particle size distribution is 6.95

### Example 17

1. 630 g of water is placed in a reactor. The water temperature is 17° C.

2. A mixture (50:50) of calcium sulfate anhydrite and calcium sulfate dihydrate is evenly added to the reactor with the operation speed of the stirrer being set to position 1. The total amount of anhydrite and dihydrate added is 870 g. After the addition the operation speed of the stirrer is raised to position 2.

3. Wait for the formation of calcium sulfate dihydrate.

4. The precipitated product is dispersed using a Diaf dissolver and Fennodispo A41 polyacrylate dispersant.

5. Other chemicals like biocide (Fennosan IT 21) are added.

6. Possible whitening treatment, grinding to crush the agglomerates and screening.

The obtained dihydrate gypsum is shown in FIG. 17.

Average particle size (D50) is 5.14 μm

The shape ratio is 12.50

The aspect ratio is 3.84

Width of the particle size distribution is 1.52 g

### Example 18

1. 185 g of water is placed in a reactor. The water temperature is 23° C.

2. A mixture (50:50) of calcium sulfate anhydrite and calcium sulfate dihydrate is evenly added to the reactor with the operation speed of the stirrer being set to position 1. The total amount of anhydrite and dihydrate added is 737 g. After the addition the operation speed of the stirrer is raised to position 2.

3. Wait for the formation of calcium sulfate dihydrate.

4. The precipitated product is dispersed using a Diaf dissolver and Fennodispo A41 polyacrylate dispersant.

5. Other chemicals like biocide (Fennosan IT 21) are added.

6. Possible whitening treatment, grinding to crush the agglomerates and screening.

The obtained dihydrate gypsum is shown in FIG. 18.

Average particle size (D50) is 5.17 μm

The shape ratio is 7.48

The aspect ratio is 2.23

Width of the particle size distribution is 5.43

### Example 19

1. 513 g of water is placed in a reactor. The water temperature is 20° C.

2. A mixture (50:50) of rotary kiln calcinated β-calcium sulfate hemihydrate and calcium sulfate anhydrite is evenly added to the reactor with the operation speed of the stirrer being set to position 1. The total amount of hemihydrate and anhydrite added is 680 g. After the addition the operation speed of the stirrer is raised to position 2.

3. Wait for the formation of calcium sulfate dihydrate.

4. The precipitated product is dispersed using a Diaf dissolver and Fennodispo A41 polyacrylate dispersant.

5. Other chemicals like biocide (Fennosan IT 21) are added.

6. Possible whitening treatment, grinding to crush the agglomerates and screening.

The obtained dihydrate gypsum is shown in FIG. 19.

Average particle size (D50) is 1.51 μm

The shape ratio is 16.27

The aspect ratio is 4.08

Width of the particle size distribution is 2.04

### Example 20

1. 178 g of water is placed in a reactor. The water temperature is 20° C.

2. A mixture (50:50) of rotary kiln calcinated β-calcium sulfate hemihydrate and calcium sulfate anhydrite is evenly added to the reactor with the operation speed of the stirrer being set to position 1. The total amount of hemihydrate and anhydrite added is 712 g. After the addition the operation speed of the stirrer is raised to position 2.

3. Wait for the formation of calcium sulfate dihydrate.

4. The precipitated product is dispersed using a Diaf dissolver and Fennodispo A41 polyacrylate dispersant.

5. Other chemicals like biocide (Fennosan IT 21) are added.

6. Possible whitening treatment, grinding to crush the agglomerates and screening.

The obtained dihydrate gypsum is shown in FIG. 20.

Average particle size (D50) is 2.38 μm

The shape ratio is 3.51

The aspect ratio is 3.51

Width of the particle size distribution is 2.45

### Example 21

1. 513 g of water is placed in a reactor. The water temperature is 20° C.

2. A mixture (1:1:1) of rotary kiln calcinated β-calcium sulfate hemihydrate, calcium sulfate dihydrate and calcium sulfate anhydrite is evenly added to the reactor with the operation speed of the stirrer being set to position 1. The total amount of hemihydrate, dihydrite and anhydrite added is 680 g. After the addition the operation speed of the stirrer is raised to position 2.

3. Wait for the formation of calcium sulfate dihydrate.

4. The precipitated product is dispersed using a Diaf dissolver and Fennodispo A41 polyacrylate dispersant.

5. Other chemicals like biocide (Fennosan IT 21) are added.

6. Possible whitening treatment, grinding to crush the agglomerates and screening.

The obtained dihydrate gypsum is shown in FIG. 21.

Average particle size (D50) is 27.09 μm

The shape ratio is 12.19

The aspect ratio is 2.38

Width of the particle size distribution is 1.04

### Example 22

1. 250 g of water is placed in a reactor. The water temperature is 20° C.

2. A mixture (1:1:1) of rotary kiln calcinated β-calcium sulfate hemihydrate, calcium sulfate dihydrate and calcium sulfate anhydrite is evenly added to the reactor with the operation speed of the stirrer being set to position 1. The total amount of hemihydrate, dihydrite and anhydrite added is 1000 g. After the addition the operation speed of the stirrer is raised to position 2.

3. Wait for the formation of calcium sulfate dihydrate.

4. The precipitated product is dispersed using a Diaf dissolver and Fennodispo A41 polyacrylate dispersant.

5. Other chemicals like biocide (Fennosan IT 21) are added.

6. Possible whitening treatment, grinding to crush the agglomerates and screening.

The obtained dihydrate gypsum is shown in FIG. 22.

Average particle size (D50) is 23.54 μm

The shape ratio is 8.06

The aspect ratio is 1.7

Width of the particle size distribution is 1.40

### EXAMPLES 23-28

### (With Crystallization Habit Modifier) and Product Application

First, general information about the syntheses and product analyses is disclosed. Then, the figures are identified, after which data about each example is presented. Finally, a table showing the raw materials, the reaction conditions and the product properties is shown.

### Synthesis

General information is first presented. A method optimization for the paper pigments was carried out. The parameters were:
Habit modifier (w-%/dihydrate DH) 0.100-0.543
Tj (jacket temperature) (° C.) 2-100
pH 3.7-7
HH (hemihydrate) (w-%) 50-80

The reaction was carried out either at system pH or the pH was adjusted to the desired value by addition of 10% NaOH or 10% H₂SO₄. The amount of habit modifier chemical is calculated as per cent of the precipitated calcium sulfate dihydrate (%/DH). The raw material in all examples was β-hemihydrate obtained by fluidized bed flash heating. The dispersing agent in all examples was Fennodispo A41.

The experiments were performed with the following equipment.

1. To a reactor with shell cooler, Tj 12-20° C., the hemihydrate is added as a batch to the water containing the crystallization habit modifier and other possible chemicals. The slurry containing 57-60% dry matter is stirred using a Heidolph-mixer (ca. 250-500 rpm). The initial pH of the slurry is measured at time t=1 min.

The progress of the reaction was followed using mixer-torque measurement and thermometers.

2. The reactor was of Hobart type N50CE, keeping the temperature of the reaction between 10-100° C. The hemihydrate and the chemicals are added batch wise to the aqueous liquid phase and a hemihydrate slurry with an initial solids of 57-80 w-% is obtained. Mixing speed is ca. 250-500 rpm. The reaction is carried out at system pH.

3. A MLH12 MAP type laboratory mixer. The hemihydrate is added batch wise to the reactor and water with chemicals is added into the hemihydrate without mixing. Mixing (ca. 200 rpm) is then turned on and the starting solids content of the slurry is 57-80 w-%. The reaction is carried out at system pH.

### Analysis

The pH and temperature of the reactor were monitored by Knick Portamess 911 pH-electrode. The morphology of the calcium sulfate dihydrate was studied by using FEI XL 30 FEG scanning electron microscope. The conversion of hemihydrate to dihydrate was analyzed using Mettler Toledo TGA/SDTA85 1/1100-thermogravimetric analyzer (TG). The crystal structure was determined with a Philips X'pert x-ray powder diffractometer (XRD). The particle size and distribution were studied using a Sedigraph 5100 particle sizer. The samples were prepared in methanol. The shape ratio and aspect ratio was measured by examining at least ten particles found in the electron microscope micrographs.

### Example 23

1. 235.82 g of deionized water is placed in the cooled reactor, when the cooler bath temperature has reached 2° C.

2. Na-n-alkyl(C10-13)benzene sulfonate (NABS) habit modifier chemical 0.6761 g (55% purity gives 0.3719 g, 0.12% of HH weight) is added to the reactor.

3. When the cooler bath has reached a temperature of 2° C., the addition of fluidized bed calcined β-hemihydrate is started. The rotation speed of the stirrer is occasionally increased during the addition. The total amount of hemihydrate (HH) added is 313.5 g (total 549,9 g, giving 57% by weight of HH). The operation speed of the stirrer is set to 400 rpm.

4. pH of the hemihydrate slurry is adjusted to 7-7.3 using 10% NaOH-solution.

5. Wait for the formation of calcium sulfate dihydrate

6. The precipitated product is dispersed using a Diaf dissolver and Fennodispo A41 polyacrylate dispersant.

7. Other chemicals like biocide (Fennosan IT 21) are added.

8. Possible whitening treatment and screening

The obtained dihydrate gypsum is shown in FIG. 23.

Average particle size is 0.57 μm

The shape ratio is ca. 27.8

The aspect ratio is ca. 3.46

Width of the particle size distribution is 0.775

### Example 24

1. 208.02 g of deionized water is placed in the cooled reactor, when the cooler bath temperature has reached 2° C.

2. 1.0599 g of EDDS (Ethylene diamine disuccinate) and 0.9591 g of Na₂-EDTA (Na-Ethylene diamine tetra acetic acid), together 2.019 g of habit modifier chemical as active substance is added to the reactor.

3. When the cooler bath has reached 2° C. temperature, the addition of fluidized bed calcined β-hemihydrate is started. Rotation speed of the stirrer is occasionally increased during the addition. Total amount of hemihydrate added is 313.5 g (a total weight of 523.54 g gives 59.9% by weight of HH). Operation speed of the stirrer is set to 250 rpm.

4. pH of the hemihydrate slurry is adjusted to 7-7.3 using 10% NaOH-solution.

5. Wait for the formation of calcium sulfate dihydrate

6. The precipitated product is dispersed using Diaf dissolver and Fennodispo A41 polyacrylate dispersant.

7. Other chemicals like biocide (Fennosan IT 21) are added.

8. Possible whitening treatment and screening

The obtained dihydrate gypsum is shown in FIG. 24.

Average particle size is 0.838 μm

Shape ratio is ca. 6.2

Aspect ratio is ca. 1.73

Width of the particle size distribution 0.838

### Example 25

1. 208.02 g of deionized water is placed in the reactor, when the cooler bath temperature has reached 2° C.

2. 1.0599 g of EDDS (Ethylene Diamine Di Succinate) and 0.9591 g of Na₂-EDTA (Na-Ethylene Diamine Tetra Acetic acid), together 2.019 g habit modifier chemicals as active substance is added to the reactor.

3. When the cooler bath has reached a temperature of 2° C., the addition of fluidized bed calcined β-hemihydrate is started. The rotation speed of the stirrer is occasionally increased during the addition. The total amount of hemihydrate added is 313.5 g (the total weight is 523.54 g, giving 59.9% HH). The operation speed of the stirrer is set to 500 rpm.

4. pH of the hemihydrate slurry is adjusted to 7-7.3 using 10% NaOH-solution.

5. Wait for the formation of calcium sulfate dihydrate

6. The precipitated product is dispersed using Diaf dissolver and Fennodispo A41 polyacrylate dispersant.

7. Other chemicals like biocide (Fennosan IT 21) are added.

8. Possible whitening treatment and screening

Obtained dihydrate gypsum is shown in FIG. 25

Average particle size 0.78 μm

Shape ratio is ca. 6.3

Aspect ratio is ca. 1.73

Width of the particle size distribution is 0.658

### Example 26

1. 5625 g of fluidized bed calcined β-calcium sulfate hemihydrate is placed in a MLH12 MAP laboratory mixer.

2. 12.4 g of habit modifier Na-n-alkyl(C10-13)benzene sulfonate (Paste A55 purity-%:55, which gives 6.82 g of active modifier) is mixed with 1875 g tap water (a total of 7512.4 g, giving 74.8% by weight of HH).

3. Water—habit modifier mixture is added to hemihydrate and mixing is started and speed is gradually increased to 225 rpm. Reaction is run at system pH.

4. Wait for the formation of calcium sulfate dihydrate

5. The precipitated product is dispersed using MLH12 MAP laboratory mixer and Fennodispo A41 polyacrylate dispersant.

6. Other chemical like biocide (Fennosan IT 21) are added.

7. Possible whitening treatment and screening

The obtained dihydrate gypsum is shown in FIG. 26.

Average particle size is 0.88 μm

Shape ratio is ca. 6.19

Aspect ratio is ca. 2.90

The width of the particle size distribution is 1.06

### Example 27

1. 720 g of rotary kiln calcined β-calcium sulfate hemihydrate is placed in a Hobart N50 CE laboratory mixer

2. 1.57 g Na-n-alkyl (C10-13) benzene sulfonate (purity-%:55 which gives 0.8635 g active modifier) is added to 387.69 g of tap water (a total of 1109.26 g gives 64.9% by weight of HH)

3. Mixing is started at mixing level of 1 and Water—habit modifier mixture is added to the hemihydrate. Reaction is run at system pH.

4. Wait for the formation of calcium sulfate dihydrate.

5. The precipitated product is dispersed using Diaf dissolver and Fennodispo A41 polyacrylate dispersant.

6. Other chemicals like biocide (Fennosan IT 21) are added.

7. Possible whitening treatment and screening

Obtained dihydrate gypsum is shown in FIG. 27

Average particle size 1.06 μm

Shape ratio is ca. 11.4

Aspect ratio is ca. 2.43

Width of the particle size distribution is 1.07

1-24. (canceled)

25. A process for the preparation of a gypsum product wherein calcium sulfate hemihydrate and/or calcium sulfate anhydrite and water are contacted so that the calcium sulfate hemihydrate and/or calcium sulfate anhydrite and the water react with each other and form a crystalline gypsum products wherein the formed reaction mixture has a dry matter content of between 34 and 84% by weight and the mixing is carried out until the crystalline gypsum product is formed.

26. The process according to claim 25, wherein the calcium sulfate hemihydrate and/or calcium sulfate anhydrite are used in such an amount that the reaction mixture formed from it/them and the water has a dry matter content of between 50 and 84% by weight.

27. The process according to claim 25, wherein the water is contacted with one of the following
calcium sulfate hemihydrate
calcium sulfate anhydrite
a mixture of calcium sulfate hemihydrate and calcium sulfate anhydrite
a mixture of calcium sulfate hemihydrate and calcium sulfate dihydrate
a mixture of calcium sulfate anhydrite and calcium sulfate dihydrate or
a mixture of calcium sulfate hemihydrate, calcium sulfate anhydrite and calcium sulfate dihydrate.

28. The process according to claim 25, wherein the calcium sulfate hemihydrate is β-calcium sulfate hemihydrate.

29. The process according to claim 25, wherein the calcium sulfate hemihydrate and/or calcium sulfate anhydrite, the water, and a crystallization habit modifier are contacted with each other so that the water and the calcium sulfate hemihydrate and/or calcium sulfate anhydrite react with each other in the presence of the crystallization habit modifier and form gypsum.

30. The process according to claim 29, wherein the crystallization habit modifier is added to the water before the calcium sulfate hemihydrate and/or calcium sulfate anhydrite.

31. The process according to claim 29, wherein the crystallization habit modifier is a compound the molecule of which has one or several carboxylic or sulfonic groups, or a salt thereof.

32. The process according to claim 31, wherein the crystallization habit modifier is selected from the group consisting of ethylene diamine succinic acid (EDDS), iminodisuccinic acid (ISA), ethylene diamine tetraacetic acid (EDTA), diethylene triamine pentaacetic acid (DTPA), nitrilotriacetic acid (NTA), N-bis-(2-(1,2-dicarboxyethoxy)ethyl aspartic acid (AES), the di-tetra- and hexa-aminostilbenesulfonic acids and their salts, sodium aminotriethoxy succinate (Na₆-TCA), and the alkylbenzenesulfonates.

33. The process according to claim 29, wherein the crystallization habit modifier is used in an amount of 0.01 to 5.0%, based on the weight of the calcium sulfate hemihydrate and/or calcium sulfate anhydrite.

34. The process according to claim 25, wherein the water used is at a temperature of 0 to 100° C.

35. The process according to claim 25, wherein the water used is water vapor.

36. The process according to claim 25, wherein the calcium sulfate hemihydrate and/or the calcium sulfate anhydrite is added to the water or a mixture of water and crystallization habit modifier.

37. The process according to claim 25, wherein the water is contacted with the calcium sulfate hemihydrate and/or the calcium sulfate anhydrite all at once or sequentially.

38. The process according to claim 29, wherein the calcium sulfate hemihydrate and/or calcium sulfate anhydrite, the water, and the crystallization habit modifier are intermixed until the calcium sulfate hemihydrate and/or calcium sulfate anhydrite and the water have reacted into gypsum.

39. The process according to claim 38, wherein the mixing is carried on until the gypsum formed is crystallized after which the gypsum is recovered.

40. The process according to claim 39, wherein the crystallized or recovered gypsum is dispersed with a dispersing agent.

41. The process according to claim 40, wherein the dispersing agent is used in an amount of from 0.01 to 5.0%, based on the weight of the gypsum.

42. The process according to claim 38, wherein the gypsum is treated with additives.

43. The process according to claim 38, wherein the gypsum is sieved to obtain gypsum particles having a desired size.

44. The process according to claim 38, wherein the gypsum is bleached.

45. A gypsum product prepared by the method according to claim 26, wherein the gypsum consists essentially of intact gypsum crystals obtained by crystallization and having a size of between 0.1 and below 2.0 μm.

46. The gypsum product according to claim 45, wherein the shape ratio of the crystals is at least 2.0.

47. The gypsum product according to claim 45, wherein the aspect ratio of the crystals is between 1.0 and 10.

48. The gypsum product according to claim 45, wherein the width of the particle size distribution is below 2.0.
